(19) United States
(12) Patent Application Publication
(10) Pub. No.: US 2021/0174085 A1
(43) Pub. Date: Jun. 10, 2021

(54) METHOD AND SYSTEM FOR OBTAINING INFORMATION FROM ANALOG INSTRUMENTS USING A DIGITAL RETROFIT

(71) Applicant: Saudi Arabian Oil Company, Dhahran (SA)

(72) Inventors: Vincent Cunningham, Thuwal (SA); Sahejad Patel, Thuwal (SA); Hassane Trigui, Thuwal (SA); Fadl Abdellatif, Thuwal (SA); Mohamed Abdelkader, Thuwal (SA); Abdoulelah Hannabi, Thuwal (SA); Abdulrahman Althobaiti, Thuwal (SA)

(21) Appl. No.: 17/109,650

(22) Filed: Dec. 2, 2020

Related U.S. Application Data
(60) Provisional application No. 62/944,127, filed on Dec. 5, 2019.
(60) Provisional application No. 62/944,607, filed on Dec. 6, 2019.
(60) Provisional application No. 62/944,765, filed on Dec. 6, 2019.

(51) Int. Cl. G06K 9/00; G06K 9/46; G06K 9/62; G06K 19/06; G06N 3/08

(52) U.S. Cl. CPC G06K 9/00671; G06K 9/4604; G06K 9/6227; G06K 2209/03; G06K 19/06037; G06N 3/08; G06K 9/6256

(57) ABSTRACT

A digital retrofit device comprises a camera, a processor coupled to the camera and configured with computer-executable instructions that cause the processor to activate the camera to capture an image and process the image so as to identify measurement data being displayed on an analog measurement instrument which is within the image captured by the camera, wherein the processing includes: identifying a type of the analog measurement instrument, identifying features of the analog measurement instrument, extract the measurement data displayed on the analog instrument based on the identified type and features of the analog instrument measurement, convert the extracted data into converted digital information, and obtain supplemental information from a database related to the analog instrument.

### CROSS-REFERENCE TO RELATED APPLICATIONS

The present disclosure claims priority to U.S. Provisional Patent Application Ser. No. 62/944,127, filed Dec. 5, 2019, U.S. Provisional Patent Application Ser. No. 62/944,607, filed Dec. 6, 2019, and U.S. Provisional Patent Application Ser. No. 62/944,765, filed Dec. 6, 2019, which are hereby incorporated by reference in their respective entireties.

### FIELD OF THE DISCLOSURE

The present disclosure relates to industrial sensors and gauges and more particularly relates to a method of converting analog readings from legacy analog instrumentation into digital information.

### BACKGROUND OF THE DISCLOSURE

Currently, digital transformation of assets and facilities is being promoted in all industries throughout all sectors. There are many driving forces behind such technologies and practices; for example, there have been reports of improvements in efficiency, safety, reduced operation costs and savings from predictive maintenance provided by digital transformation. Additionally, digitization is required to take advantage of technologies related to deployment of the Internet of Things (IoT).

However, a digital solution may not always be possible or available and the costs of converting existing facilities having analog inspection and monitoring equipment to a digital mode can outweigh the financial benefits. This is particularly true in well-established and aging facilities where the instrumentation used is mostly analog in nature. A typical example of this would be a pressure gauge on a vessel or tank.

The present disclosure solves these and other problems with a technical solution as disclosed herein.

### SUMMARY OF THE DISCLOSED EMBODIMENTS

The present disclosure solves these and other problems with a technical solution as disclosed herein.

The present disclosure provides a digital retrofit device comprising a camera, a processor, and a display. The processor is coupled to the camera and configured with computer-executable instructions that cause the processor to activate the camera to capture an image, process the image so as to identify measurement data being displayed on an analog measurement instrument which is within the image captured by the camera, wherein the processing includes identifying a type of the analog measurement instrument, identifying features of the analog measurement instrument, extracting the measurement data displayed on the analog instrument based on the identified type and features of the analog instrument measurement, converting the extracted data into converted digital information, obtaining supplemental information from a database related to the analog instrument, and superimposing the additional information in a graphical representation over the captured image of the analog instrument in real time in the display together with the digital information. The display is coupled to the processor upon which the digital information and supplemental information is displayed to a wearer of the smart glasses.

The present disclosure also provides a method of converting analog readings from an analog instrument into digital information. The method comprises receiving an image of an analog instrument including a measurement data displayed on the analog instrument into a memory of a portable electronic device having a programmed processor, identifying both a type and features of the analog instrument using the programmed processor, extracting the measurement data displayed on the analog instrument based on the identified type and features using the programmed processor, converting the extracted data into digital information using the programmed processor, and obtaining supplemental information from a database related to the analog instrument.

The present disclosure further provides a method of updating a condition of an analog instrument in a facility. The method comprises receiving measurement data, a time of measurement, and an instrument identification code from a device to capture and digitize measurement data obtained from a visual display of the analog instrument, scheduling a time for a next measurement by the operator based on a threshold duration from the received time of measurement, and sending an alert to the device to take another measurement when the threshold duration has elapsed.

### BRIEF DESCRIPTION OF THE DRAWINGS

FIG. 1 is a schematic illustration of a system for converting analog reading from legacy analog equipment into digital information using a digital retrofit device according to the present disclosure.

FIG. 2 is a block flow diagram of a method for converting analog reading from legacy analog equipment into digital information according to the present disclosure.

FIGS. 3A through 3D are examples of analog instrumentation readouts that can have their outputs digitized and managed in accordance with the disclosure.

FIG. 4 is a further block flow diagram describing an embodiment of a method for converting analog reading from legacy analog equipment into digital information using machine learning according to the present disclosure.

FIG. 5 is a flow chart of a method for alerting operators to obtain and digitize a measurement of an analog instrument display according to an embodiment of the present disclosure.

### DETAILED DESCRIPTION OF CERTAIN EMBODIMENTS OF THE DISCLOSURE

The present disclosure provides a “retrofit” solution to the problem of the incompatibility between legacy analog equipment and digital platforms. A digital retrofit device (“DR device”) positioned at an analog instrument is configured with an application (hereinafter referred to as an analog measurement conversion application (“AMC application”)) that is adapted to capture visual analog information displayed on analog instrumentation, determine features of the captured visual information and convert the information into digital form. With advances in image recognition tools and Artificial intelligence (particularly Machine Learning), the analog instrumentation can be identified by type and other information. In addition, the measurement range and safe operating region of the identified analog instrument can be determined using the application.

The DR device according to the present disclosure is equipped with a camera that is directed toward the display of an analog instrument to be monitored. Either at set time intervals, or at the direction of an operator (manual or remote), the camera of the DR device captures an image of the instrument display. The AMC application receives the captured instrument image and applies a machine learning algorithm to identify, from the captured image, the instrument type (e.g., measurement gauge type) and the displayed measurement value (e.g., the angle of a dial, the level of a vertical or horizontal level gauge, etc.). Upon identification, the measured value is extracted and digitized. In other words, the value is converted from a visual representation into numeric data. The DR device can also include a display on which a he captured image of the analog instrument display can be presented. Alternatively, the AMC application can be configured to render a visual representation of the analog instrument display and the measurement on the display of the DR device is in a form similar form to that in which it is captured (as a dial, level indicator, etc.). In addition, the analog display measurement can be displayed more simply in alphanumeric form. The captured image and digitized information is then transmitted to a database server.

According to a salient aspect of the invention, when the AMC application identifies a gauge or instrument, that information can be presented to an operator for confirmation. This can be used as part of the training of the AMC application to correctly identify gauges and instruments. This enables leveraging of the information exchange between the AMC application and the user to apply machine learning to additional gauges throughout a facility.

In certain embodiments, the AMC application is equipped with Augmented Reality (AR) capability. An AR application can be used to establish an interaction between the DR device and a database server that stores accumulated information regarding the monitored analog instruments. Through this interaction the DR device transmits identification information regarding an analog instrument being monitored to the database server, and, in return, the database server transmits back supplemental information, notifications and alerts that can be displayed on the DR device to provide an enhanced interface. For example, after a measurement on an identified analog instrument is captured and digitized and communicated to the database server, the database server can access information regarding the identified device and send back a range of expected measurement values, initiate highly visible or audible alert if the measured value is outside of the expected range, and schedule a time for a subsequent measurement of the identified instrument. The AR application can then render the supplemental information on the display of the DR device. The supplemental information can be superimposed over the image of the analog instrument in the device display in real time (as an overlay). The superimposed information can be rendered directly on the image of the instrument or can be rendered as “floating” in the vicinity of the image.

The superimposed information can include for example, the function of the instrument a nominal safe range (minimum & maximum), historical data graphs and equipment conditions, a digitally converted reading, colored coding on segments of the instrument scale to indicate safe, critical or dangerous operating conditions, “ghost” needle positions to display measurements captured in the recent past, or an average of a set time interval, text and/or visual instructions for corrective actions if the analog instrument provides an abnormal reading, a check list of all instruments to be monitored and their status (inspected or not yet inspected), alerts or alarms received from other operators of the facility, and indications of hazards such as toxic chemicals. The AR application can also sharpen and improve the image of the instrument which is useful particularly when the instrument display is occluded by dirt or water. An AR display can include any or all of the above and various combinations thereof.

In some facilities, the analog instruments are equipped with a unique identification code, such as a QR code, which differentiates each instrument and provides a key code for storing information regarding each instrument. When the DR device is used to capture visual information from an analog instrument display, the DR device can also capture the identification code of the analog instrument to associate the captured visual and digitized image with the scanned code. If the code is not within the normal field of view of the DR device, the magnification setting of the camera can be changed or the tilt of the device can be changed electromechanically (e.g., by a pivoting element). In some embodiments, the code can be used as a backup for confirming the device type identified using the machine learning algorithm. Furthermore, in some implementations, the DR device is equipped with navigation application, such as a GPS locator. During an instrument reading, the GPS location of the instrument can be recorded and sent to the database server in addition to the instrument code and digitized measurement data. Over time, the information stored in the database server can provide a detailed overview of the status of analog instrumentation at all parts of a facility.

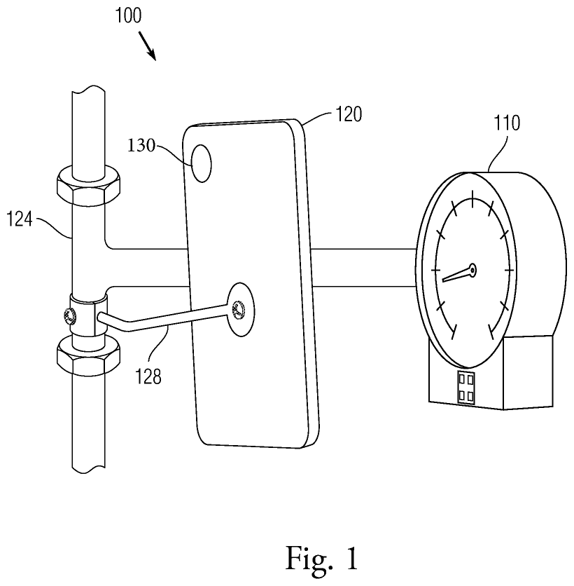

FIG. 1 is a schematic illustration of a system for converting analog readings from legacy analog equipment into digital information using a digital retrofit device according to an embodiment of the present disclosure. In the system of FIG. 1, an analog instrument 110 having an identification code such as a QR code is shown coupled to a pipe 124 for reading a parameter, such as pressure, of a flow within the pipe. More generally, the analog instrument 110 is a gauge associated with an asset such as, for example, a pressure vessel, pipeline, tank, reactor, motor, etc. The analog instrument 110 is installed and associated with the asset in order to measure the desired parameter of the asset. For instance, the measurement can be of pressure, temperature, humidity, vibration, voltage, current, etc. The analog instrumentation has a visible display or readout that operators conventionally must review in order to manually record the relevant data. For instance, the readout can comprise a needle dial, a liquid level, an analog numeric display, or a or combination of the foregoing.

A DR device 120 executing the AMC application according to the present disclosure is shown. The DR device is affixed to an asset in the facility such as pipe 124 by a fixture 128 such as a vise or clamp. The DR device includes a camera 130 and is affixed to the pipe in such manner that the aperture of the camera faces the display of the analog instrument 110. The DR device also includes an onboard processor and memory and can communicate wirelessly with a server (not shown in FIG. 1) to which it sends acquired image data and from which it can obtain supplemental information about the analog instrument such as historical data records. The DR device can also includes a display (also not shown) through which the supplemental information obtained from the server can be rendered in an augmented reality (AR) display.

As will be appreciated, the processor DR device 120 is configurable by code provided to the processor from the memory, which code can be provided to the memory by loading the code into memory by a wired or wireless connection to the server. Depending on the implementation, the processing can include through modules having code to further configure the processor either as discrete functions or through combined-functionality in a single module, one or more of the following functions

An embodiment of a method of converting analog readings from legacy analog equipment into digital information according to the present disclosure includes the following steps. In a first step, a DR device configured with the AMC application captures an image of the analog instrument. Upon receiving a captured image of the analog instrument, the AMC application first scans the instrument to detect an identification code such as a QR code and any other information about the instrument that is available such as gauge type, units employed, parent equipment, etc.

In a following step, the AMC application employs one or more computer vision algorithms to acquire the measurement displayed on the analog instrument. For example, the algorithm learnings by a process of machine learning to detect measurement display features such as dials and level indicators and to detect the value indicated by the display features. In this step the measurement displayed on the analog instrument is converted into a digital value.

To obtain further information, the AMC application connects to a server, and using the scanned unique identification code, uploads the measurement to the server for record keeping. This allows a control room to track and display the trends of the measurement for the identified device. Additionally, the AMC application downloads from the server supplemental information about the analog instrument including an expected range (nominal safe range) of the measured parameter, historical measurement data, and maintenance information (e.g., if the instrument has been refitted or adjusted). Using the downloaded information, the AMC application generates an augmented reality (AR) display in which the supplemental information is displayed adjacent to and/or as an overlay over an image or graphical representation of the analog instrument. If the measured parameter value is outside of a safe range shown in the AR display, the DR device can issue an alert (e.g., an audio alarm signal, a text message, etc.) so that maintenance personnel can immediately take or at least initiate correction action.

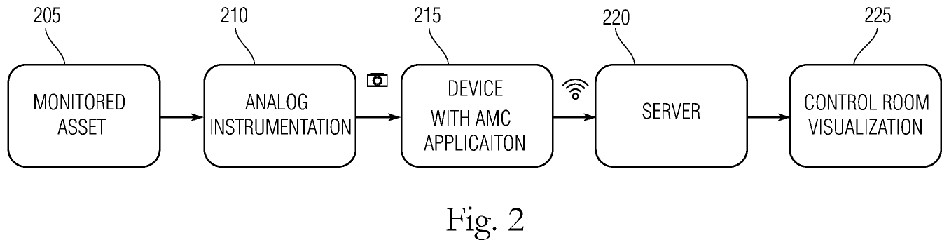

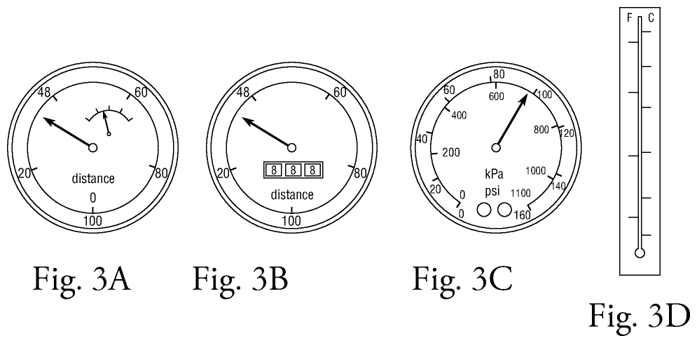

FIG. 2 is a simplified block flow diagram of the method of converting analog readings from legacy analog equipment into digital information according to the present disclosure. Information flow in FIG. 2 is from left to right. In FIG. 2, information flow from a monitored asset 205 is an asset being monitored such as a pressure vessel, pipeline, tank, reactor, motor, etc. to analog instrumentation 210. The analog instrument 210 is the equipment in place to measure a desired parameter of the asset, for example, but without limitation, pressure, temperature, humidity, vibration, voltage, and current. The analog instrumentation 210 has a visual readout or display such as a needle dial, liquid level, analog numeric display or combination thereof that enables recordation of the relevant data. FIGS. 3A though 3D show examples of common analog instrument display types. In some implementations, the analog instrumentation includes an identification code such as a QR code. A DR device 215 configured with an AMC application according to the present disclosure and equipped with a camera is placed in-front of the analog readout of the instrumentation 210 to capture a digital image of the reading and any identification code on the instrumentation. The DR device 215 uses the AMC application to determine the type of instrumentation using visual recognition, extract features to determine areas of the image containing useful information, and then extract data to determine the readout parameters from the visual data. The AMC application can further identify if an abnormal readout is captured (a readout above or below an expected operating range) and identify if the analog instrumentation is functioning appropriately.

The DR device 215 sends the data it generates to a server 220 (or stores the data locally if there is no connection). The data transferred to the server is stored for record keeping, used for comparisons with historical data and can also be used for notification purposes. Data captured from all of the gauges can be visualized in a control room 225. In another embodiment, the processing of the image information is performed on the server 220 rather than on the AMC application executed on the DR device. This can be helpful if there is too much processing to be done locally.

The AMC application can utilize artificial intelligence algorithms for detecting the analog readout from the analog instrumentation and for converting the readout into digital information. As noted, the AMC application can use augmented reality to superimpose the readout in real time on top of an image of the analog instrumentation along with other useful information. The AMC application can scan an identifier such as a QR code attached to the analog instrumentation to uniquely identify which instrumentation being monitored and recorded. The visual recognition capability of the AMC application includes determining the type of analog instrumentation (such as needle gauge, liquid level, analog numeric etc.), the type of measurement made by the instrumentation (kPa, MPa, psi, etc.), and the scale and range of parameter values appearing on the instrumentation. The DR device can also locally store a geographical map that indicates the locations of the analog instrumentation in a facility, whether the instrumentation has been scanned, and instrumentation type among other types of data. One of the advantages of the AMC application in terms of device identification and the interaction with users to provide training to the system in order to correct or refine the identifications being made is that it is dynamic and, when trained properly as described below, is less prone to error as it is not dependent on a QR code, which can be applied to the wrong instrument, particularly in a large facility with a large number of instruments.

The AMC application can further provide a warning to operators when abnormal readings are detected. For example, the application can detect unusual oscillations in measurement, or fixed measurements overtime when fluctuations would be expected such as when a needle is stuck in a fixed position, or data that does not conform to the historical trends of the instrument. Machine learning algorithms can be used to detect anomalous measurements. Similarly, specific warnings can be provided when analog instrumentation is defective. The AMC application is flexible in that is can measure range of instrumentation such as pressure, voltage, current, temperature and humidity gauges and other sensors, such as hazardous gas detectors. The DR device can send data wireless to a server where additional processing can occur. In some implementations, the DR device stores data sequentially in the server, at which data modeling and analytics are performed. All data relating to the readouts of the analog information can be stored for general access (for example, on a cloud server) and operators can access the stored data for further analysis and to check the history of asset integrity in a control room setting or otherwise. The DR device or control room display can provide operators with on-screen instructions for the purpose of training.

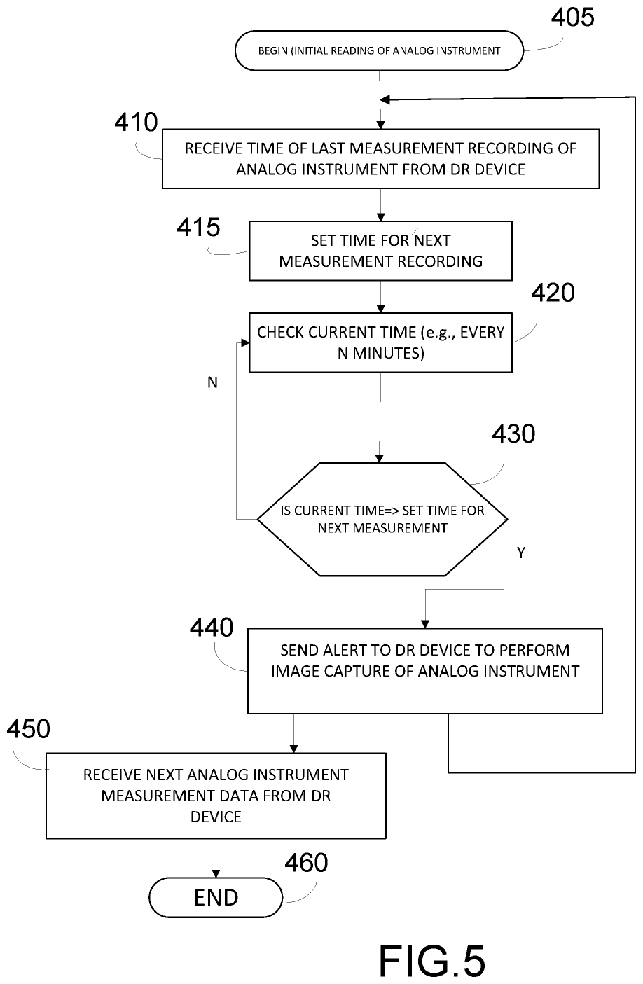

In addition, as part of a monitoring and maintenance (condition updating) scheme, the server can create a schedule that directs the DR devices to take measurements from particular instruments at specified times. This scheme helps to ensure that the analog instruments are checked regularly and that a subset of instruments (e.g., parts of facilities that are comparatively difficult to access) are not neglected. FIG. 5 is a flow chart of a continual condition updating scheme according to an embodiment of the present disclosure. In step 405 the method begins with an initial or previous reading of a specific analog instrument by a DR device. In step 410, a database server or other processor referred to as the “scheduler” with having access to the analog instrument database obtains stored measurement information of the initial or previous reading and determines the time at which the initial or previous reading was made. In a following step 415, the scheduler database sets a time for taking the next measurement from the analog instrument. The set time can be determined by a periodic measurement rate, say once every set number of days or hours. For example, if the periodic measurement rate is set at every twelve hours, and the last measurement was made at 6 A.M., the scheduler sets the next measurement time at 6 P.M. The scheduler has a timer and in step 420, checks the current time continuously (e.g., every n milliseconds) and compares the current time with the next measurement time in step 440. If the current time is less than the next measurement time, the method cycles back to step 420. If the current time is equal to or greater than the set next measurement time, in step 440 the scheduler sends an instruction to DR device to capture an image of the specific analog instrument. After a new measurement has been received in step 450, the method ends in step 460.

The AMC application can also facilitate monitoring the instrument inventory in a facility. The monitoring can include automatic instrument replacement and maintenance scheduling, as well as information regarding instruments that currently require maintenance based on age and display readouts. Over time instruments have a tendency to acquire an inherent bias (creep) which requires correction. Faulty instruments recommended for replacement can be marked out in the AR display and a purchase order can be initiated by the user on-site using the portable device.

Since instruments are located throughout a facility in many locations, instrument inspection can be performed in parallel with related facility wide safety inspections. In connection with such additional inspection, the AMC application can be used to acquire and report associated information. For example, the AMC application can be used to report a fault at a facility, a hazardous situation, and/or an area that requires attention. The advantage of the platform being used is that enables photographic evidence to be taken and sent directly during instrument monitoring activities.

### MACHINE LEARNING EMBODIMENT

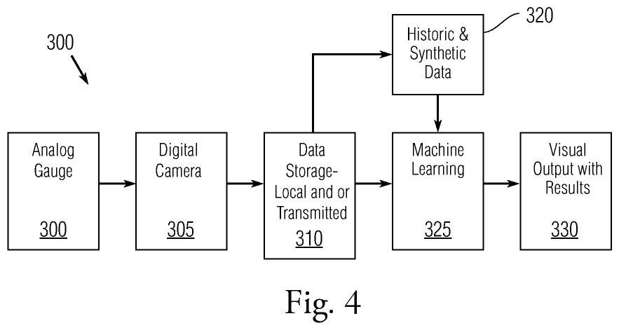

The present disclosure provides an embodiment in which machine learning is used to determine an analog readout and convert the readout into digital information. FIG. 4 is a further block flow diagram describing this embodiment. In a first step 400, a DR device with a camera is positioned in-front of the analog instrument that is being monitored. It is helpful to capture as much of the instrument in the image as possible. In step 405, the camera captures one or more images of the analog instrument. The image(s) can be captured continuously or during periodic instants of time (snapshots). In step 310, the image data is stored locally on the DR device and/or transmitted to a remote data storage unit or cloud-based platform. In step 320, the image data is stored in a database that keeps a historical record for training an algorithm optimization. In step 325, which can be performed before, simultaneously or after step 320, the image data is preprocessed (e.g., normalized, vectorized) to ensure consistency for the machine learning or artificial intelligence algorithm (collectively referred to as “machine learning algorithm”). The machine learning algorithm can be a trained model that, in step 330, generates an output based on the characteristics of the input image data. The data output can thereafter be used for further processing and display. As examples, the output can be used to trigger an alarm in the case of detection of abnormal behavior, or for presenting graphical representation of the values recorded.

Specifically, a “machine learning algorithm” as meant herein is an algorithm that employs forward and backward propagation, a loss function and an optimization algorithm such as gradient descent to train a classifier. In each iteration of the optimization algorithm on training data, an output based on estimated feature weights are propagated forward and the output is compared with data that has been classified (i.e., which has been identified by type). The estimated weights are and then modified during backward propagation based on the difference between the output and the tagged classification. This occurs continually until the weights are optimized for the training data. Generally, the machine learning algorithm is supervised meaning that it uses human-tagged or classified data as a basis from which to train. However, in a prefatory stage, a non-supervised classification algorithm can be employed for initial classification as well. In the context of the present disclosure, the non-supervised classification algorithm can be used to differentiate pressure gauges from temperature gauges in a group of samples, for example. This training enables the AMC application to output gauge or instrument identifications, and in some embodiments, certain end users, such as those known to the application as having authority to make changes, can provide feedback that makes adjustments to the identifications to inform the machine learning engine of any human override or change.

The machine learning algorithm is used to make predictions/decisions based on an ability to ‘learn’ from previous data. This previous/historical data is fit to different models using the algorithm. There are several known algorithms that can be used, these include (but not limited to): Convolutional Neural Networks (CNNs); Recurrent Neural Networks (RNNs); ensemble learning methods such as adaptive boosting (also known as “Adaboost” learning); decision trees; and support vector machines. However, any other supervised learning algorithm can be used and the above algorithms can be used in combination.

The procedure for incorporating a machine learning algorithm into the process for converting analog reading into digital information can be broken down into the following steps for image analysis. Data collection is the first step which determines the overall accuracy of the machine learning model. Sufficient data is provided to ensure that there are no problems with sampling and bias. In this application there are several sources for data including, for example, images of different analog instrumentation dials from data sheets, photographs from actual plant instrumentation, images from web searches. Collected data is then assessed for trends, outliers, exceptions, and incorrect, inconsistent or missing information. Geographic/location information is incorporated during this determination.

The resulting assessed data is formatted to ensure consistency. The formatting can preprocessing steps such as ensuring a uniform aspect ratio, scaling the images appropriately, normalization input parameters to have a similar distribution, determining means and standard deviations of input data, reducing dimensionality to enhance processing speed (such as collapsing RGB channel into a single grey-scale channel) and data augmentation which involves adding variations to the data of a set to expand the sample size. Data quality improvement steps can also be performed. For example, erroneous images (images having erroneous or missing data) can be removed, the mean or standard deviation can be used to filter data and observe quality. For example, if the standard deviation of an image set provides a blurry image of a recognizable feature (i.e. gauge) then the data set is typically good, however if the standard deviation provides a non-recognizable blur image then, there is likely too much variation in the data set.

In some implementations, feature engineering can be incorporated. Feature engineering involves converting raw image data into features that can be used by the algorithm as a pattern to learn so that it can later detect such patterns in future images. To perform this task a multitude of methods can be used, the most common of which are edge detection (sharp changes in image brightness), corner detection, blob detection (regions in images that differ in properties), ridge detection (specific software to detect ridges has been developed), and scale invariant feature transform (which provides object recognition and local features). Additionally, data can be split into a training set used to train the algorithms and an additional set for evaluating the trained algorithm. This step is used to refine and optimize the machine learning model. This step can be illustrated with respect to an example instrument display type such as shown in FIG. 4A. As shown, the display is circular in outline and contains three features of particular interest: a circular scale along which alphanumeric indicators are positioned at intervals around the circumference; an arrow (dial) oriented toward a particular point on the circular scale; and a smaller arc-like scale with an accompanying arrow (dial) which indicates the measurement as a relative percentage of a range. During image analysis the algorithm can learn to distinguish each of these features as regions of interest from which to extract and digitize measurement data.

Systems in accordance with the disclosure have one or more of the following attributes: the ability to detect an analog readout from analog instrumentation and converting it to a digital readout; the ability to detect and determine the type of analog instrumentation (needle gauge, liquid level, analog numerics, etc.; the ability to determine the type of measurement taking place (kPa, MPa, psi, etc.); the ability to detect and determine the scale and range on the analog instrumentation; the ability to store recorded values locally and transmit to a storage location; the ability of a system employing the solution of this disclosure to provide a physical location identification of the analog instrument being measured (through GPS location, asset tagged number on map/plan of facility, etc.); the ability of a system employing the solution of this disclosure to provide a warning to operators when abnormal readings are measured i.e. oscillation in measurement, fixed measurement overtime when fluctuations would be expected (needle stuck in fixed position); the ability to inform/alarm operators when the data does not conform to the historical trends of the gauge, with our without the assistance of a machine learning module operating on the data; the ability of a system employing the solution of this disclosure to provide a warning to personnel when analog instrumentation is defective; the ability of a system employing the solution of this disclosure to measure a wide multitude of gauges (pressure, voltage, current, temperature, humidity, etc.; and the ability to detect, with in-build sensors (for example, a gas sensor) and report situations (for instance, gas leaks and hazardous/flammable plumes using gas sensor readings).

From the foregoing, it should be understood that trained machine learning systems and methods in accordance with the present disclosure determine, among other things, a numeric value from an analog gauge with recognition of the type of gauge being read and, with actions that can be taken automatically in response to the values so-determined in relation to parameters and ranges maintained for the systems to which the analog gauge is associated.

The methods described herein may be performed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Notably, the figures and examples above are not meant to limit the scope of the present application to a single implementation, as other implementations are possible by way of interchange of some or all of the described or illustrated elements. Moreover, where certain elements of the present application can be partially or fully implemented using known components, only those portions of such known components that are necessary for an understanding of the present application are described, and detailed descriptions of other portions of such known components are omitted so as not to obscure the application. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present application encompasses present and future known equivalents to the known components referred to herein by way of illustration.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A digital retrofit device comprising:
a camera;
a processor coupled to the camera and configured with computer-executable instructions that cause the processor to:
activate the camera to capture an image;
process the image so as to identify measurement data being displayed on an analog measurement instrument which is within the image captured by the camera, wherein the processing includes:
identifying a type of the analog measurement instrument;
identifying features of the analog measurement instrument;
extract the measurement data displayed on the analog instrument based on the identified type and features of the analog instrument measurement;
convert the extracted data into converted digital information; and
obtain supplemental information from a database related to the analog instrument;
superimpose the additional information in a graphical representation over the captured image of the analog instrument in real time in the display together with the digital information; and
a display coupled to the processor upon which the digital information and supplemental information is displayed to a wearer of the smart glasses.

2. The digital retrofit device of claim 1, wherein the digital retrofit device is fixed in position with respect to the analog measurement instrument and oriented so as to be able to capture the image of the analog measurement instrument.

3. The digital retrofit device of claim 1, further comprising:
a memory unit coupled to the processor to which the processor delivers the converted digital information for storage.

4. The digital retrofit device of claim 3, further comprising a wireless communication unit coupled to the memory unit adapted to transmit the converted digital information to a database server.

5. The digital retrofit device of claim 4, wherein the processor is further configured with computer-executable instructions that cause the processor to request the supplemental information from the database server and to superimpose the additional information in a graphical representation in the display together with the digital information.

6. The digital retrofit device of claim 1, wherein the supplemental information includes nominal safe range data and instrument condition information of the analog instrument.

7. The digital retrofit device of claim 1, wherein the processor is further configured with computer-executable instructions that cause the processor to scan and identify an identification code on the analog measurement instrument.

8. The digital retrofit device of claim 7, wherein the processor is further configured to:
determine whether the extracted measurement data is within an expected range of values or within historical trends;
assess whether the analog instrument is functioning properly based on whether the extracted measurement data is within the expected range or historical trends; and
generate a graphical alert on the display if it is determined that the analog instrument is functioning outside of the expected range or historical trends.

9. The digital retrofit device of claim 1, wherein the processor is further configured to identify a type and features of the analog measurement instrument using a supervised machine learning algorithm that is trained to classify types and features of analog instruments based on tagged training data.

10. The digital retrofit device of claim 9, wherein the processor is further configured to run a trained classifier trained using a supervised machine learning algorithm to perform at least one of edge detection, corner detection, and blob detection

11. The digital retrofit device of claim 7, further comprising a GPS sensor adapter to output a current location of the analog instrument during scanning of the identification code on the analog instrument and to associate the current location with the analog instrument.

12. A method of converting analog readings from an analog instrument into digital information comprising:
receiving an image of an analog instrument including a measurement data displayed on the analog instrument into a memory of a portable electronic device having a programmed processor;
identifying both a type and features of the analog instrument using the programmed processor;
extracting the measurement data displayed on the analog instrument based on the identified type and features using the programmed processor;
converting the extracted data into digital information using the programmed processor; and
obtaining supplemental information from a database related to the analog instrument.

13. The method of claim 12, further comprising:
displaying the supplemental information;
determining whether the extracted measurement data is within an expected range of values; and
assessing whether the analog instrument is functioning properly based on whether the extracted measurement data is within the expected range or within expected historical trends.

14. The method of claim 12, further comprising capturing the visual analog information using a camera.

15. The method of claim 12, wherein the supplemental information includes nominal safe range data and instrument condition information of the analog instrument.

16. The method of claim 12, wherein features of the analog instrument identified include a type of measurement made by the analog instrument, and a scale and range of parameters values appearing on the analog instrument.

17. The method of claim 12, further comprising receiving an image of a code unique identifying the analog instrument.

18. The method of claim 17, wherein the code uniquely identifying the analog instrument is a QR code.

19. The method of claim 12, further comprising:
compiling a training data set including image data of analog instruments that have been classified by type;
executing a machine learning algorithm to train a classifier to determine an analog instrument type based on image data; and
determining the type of the analog instrument in the received image using the trained classifier.

20. The method of claim 19, further comprising determining converting the received image into features using at least one of edge detection, corner detection, blob detection, ridge detection and scale invariant feature transform.

21. The method of claim 12, wherein the machine learning algorithm includes at least one of a neural network, a convolutional network, and a recurrent neural network.

22. The method of claim 17, further comprising:
determining a location of the analog instrument, storing the location in association with the code identifying the analog instrument.

23. The method of claim 13, further comprising generating an alert if it is determined that the analog instrument is not functioning properly.

24. A method of updating a condition of an analog instrument in a facility comprising:
receiving measurement data, a time of measurement, and an instrument identification code from a device to capture and digitize measurement data obtained from a visual display of the analog instrument;
scheduling a time for a next measurement by the operator based on a threshold duration from the received time of measurement; and
sending an alert to the device to take another measurement when the threshold duration has elapsed.

25. The method of claim 24, wherein the alert is rendered as supplemental information on a display of the device.
